(19) United States
(12) Patent Application Publication
(10) Pub. No.: US 2006/0029712 A1
(43) Pub. Date: Feb. 9, 2006

(54) Pulp mimetic

(75) Inventors: Roger E. McPherson, Muscatine, IA (US); Leona E. Bishop, Muscatine, IA (US)

Correspondence Address: BANNER & WITCOFF, LTD., TEN SOUTH WACKER DRIVE, SUITE 3000, CHICAGO, IL, 60606, US

(73) Assignee: Grain Processing Corporation, Muscatine, IA (US)

(21) Appl. No.: 11/192,417

(22) Filed: Jul. 29, 2005

Related U.S. Application Data
(60) Provisional application No. 60/599,416, filed on Aug. 6, 2004.

(51) Int. Cl. A23L 1/05

(52) U.S. Cl. 426/573

(57) ABSTRACT

Holocellulose is used in combination with fruit or vegetable juice as a substitute for fruit or vegetable pulp in food pulps and purees requiring a food pulp ingredient. For example a corn hull holocellulose the mimetic can replace ingredients such as tomato paste and apple sauce, both of which are costly additives for sauces and bakery products. Corn hull holocellulose, combined with fruit or vegetable juice, provides the expected texture ordinarily provided by the food pulp. Moreover, expected tastes and aromas of the products may be obtained using corn hull holocellulose when combined with juices such as tomato and apple juice.

This application claims priority to provisional application Ser. No. 60/599,412 filed Aug. 6, 2004, which is hereby incorporated by reference in its entirety.

### FIELD OF THE INVENTION

The invention is directed to the field of food pulps, such as tomato paste and apple sauce.

### BACKGROUND OF THE INVENTION

Numerous food pastes and sauces (collectively “pulps”) are prepared commercially from fruits and vegetables. These pulps are sometimes consumed as-is, but more frequently are used as ingredients in the preparation of composite food products. For instance, tomato paste is an essential ingredient in numerous manufactured food products such as pasta sauce and catsup. Tomato paste possesses a characteristic flavor and odor, and the texture of tomato pulp supplies the expected mouthfeel associated with the composite food products in which it is used. Additionally, tomato paste provides necessary water retention properties for moistness in final products. Tomato paste is expensive and sometimes of limited supply.

Similarly, apple sauce is an essential ingredient in numerous manufactured food products. Like tomato paste, apple sauce provides characteristic flavor, texture, and mouthfeel. Apple sauce also is used to fashion composite products such as bakery products, pastries, and desserts, and provides water retention properties. Apple sauce is expensive and sometimes of limited supply.

Because of the expense of these food pulps, the prior art has taught to use various products to simulate the texture and mouthfeel of such food pulps. For instance, U.S. Pat. No. 4,980,190 discloses a mixture of summer squash pulp and sweet red peppers, which is said to be useful as a tomato puree substitute. U.S. Pat. No. 5,192,569 teaches to mix microcrystalline cellulose and guar gum to create fat-like bulking agents for aqueous foods. Other gums are used for other purposes in the prior art; for instance, U.S. Pat. No. 4,588,530 teaches to blend gum arabic and pectin with tomato or apple juice to yield a beverage.

The invention seeks to provide a food pulp mimetic. In highly preferred embodiments, the food pulp replacement should be fashioned from ingredients that are inexpensive and that are in abundant supply.

### BRIEF SUMMARY OF THE INVENTION

A mixture of holocellulose and natural or synthetic fruit juice can mimic food pulps such as tomato paste and apple sauce. For instance, tomato paste can be replaced by a mixture of holocellulose and tomato juice in manufactured food formulations. Apple sauce can be replaced by a mixture of holocellulose and apple juice in manufactured food formulations.

In a first preferred embodiment, the invention is directed to a food product having substantially the characteristics of and simulating tomato paste for use in food products as a substitute tomato paste comprising a mixture of corn hull holocellulose and tomato juice in amounts sufficient to simulate tomato paste. The tomato paste mimetic may be used to form composite products, such as a pasta sauce.

In a second preferred embodiment, the invention is directed to a food product having substantially the characteristics of and simulating apple sauce for use in food products as a substitute apple sauce comprising a mixture of corn hull holocellulose and apple juice in amounts sufficient to simulate apple sauce. The apple sauce mimetic may be used to form composite products, such as desserts.

### DETAILED DESCRIPTION OF THE PREFERRED EMBODIMENTS

In accordance with the invention, holocellulose is employed in the preparation of pulp mimetics. Generally, the combination of cellulose and hemicelluloses within a plant is collectively known as holocellulose, and this material usually accounts for 65 to 75% of plant dry weight. Holocellulose may be obtained from a variety of sources, such as corn hulls, cottonseed hulls, peanut hulls, oat hulls, soybean hulls, palm hulls, coconut hulls, and lees from rice, wheat, beets or potatoes. The preferred holocellulose is corn hull holocellulose, which is obtained by treatment of corn hulls. The remaining discussion focuses on corn hull holocellulose, but it should be understood that holocellulose obtained from other sources are within the scope of the instant invention.

The domestic U.S. hybrid corn crop is enormous and stable, and the composition of the corn seeds does not vary significantly. Corn crops provide a reliable, low cost, and consistent source of hulls, bran, and spent germ as byproducts from the production of starch, corn flour, protein and oil. Corn hulls from the corn wet milling industry are a good, inexpensive, source for holocellulose.

Corn hull holocellulose may comprise hemicellulose, cellulose, starch, protein, fat, acetic acid, ferulic acid, diferulic acid, coumaric acid, and trace amounts of other materials such as phytosytosterols and minerals. For example, an accepted composition of commercially produced corn hulls or corn bran is as follows:

| | |
|---|---|
| Hemicellulose | 56.38% |
| Cellulose | 18.79% |
| Starch | 8.14% |
| Protein | 7.90% |
| Fat | 1.69% |
| Acetic acid | 3.51% |
| Ferulic acid | 2.67% |
| Diferulic acid | 0.58% |
| Coumaric acid | 0.33% |
| Other | (trace) |

The polymers that comprise holocellulose are made up of simple sugars, such as D-glucose, D-mannose, D-galactose, d-xylose, 1-arabinose, d-glucoronic acid, and other sugars such as L-rhamnose and D-fructose. Cellulose is a glucan polymer of D-glucanopyranose units linked together via β-(1-4)-glucosidic bonds. The average DP (degree of polymerization) for plant cellulose ranges from a low of about 50 to about 600. Cellulose molecules are randomly oriented and have a tendency to form inter- and intra-molecular hydrogen bonds. Most isolated plant cellulose is highly crystalline and may contain as much as 80% crystalline regions. The hemicellulose fraction of plants is composed of a collection of polysaccharide polymers with a typical lower DP than the cellulose in the plant. Hemicellulose contains mostly D-xylopyranose, D-glucopyranose, D-galactopyranose, L-arabinofuranose, D-mannopyranose, and D-glucopyranosyluronic acid, with minor amounts of other sugars. The various forms of hemicellulose and the ratio of hemicellulose to cellulose is not well defined and may vary from plant to plant or from crop to crop within a given plant.

Any suitable holocellulose may be used in conjunction with the invention, so long as it is food-grade. In accordance with preferred embodiments of the invention, the holocellulose is prepared as taught in U.S. Pat. No. 4,104,463 (Antrim et al.) and U.S. Pat. No. 4,239,906 (Antrim et al.). As set forth in U.S. Pat. No. 4,104,463, corn hull holocellulose may be prepared from corn hulls via alkaline hydrolysis using alkali. Sufficient water should be present to solubilize the alkali and non-carbohydrate fraction of the corn hulls, but the moisture should be insufficient to solubilize the majority of the hemicellulose in the plant. The amount of water tolerated depends on a number of factors, such as the particular solvent, the temperature of treatment, and the like, which factors are deemed to be within the purview of one skilled in the art. In accordance with one method, the hydrolysis is performed using an alkaline water-miscible organic solvent system. The extraction solution should comprise from about 60 to about 90% solvent and the remainder water. Water-miscible organic solvents usable in such process include acetone, methanol, ethanol, propanol, isopropanol, s-butyl alcohols and t-butyl alcohols, and mixtures thereof, and similar materials. The corn hulls should be treated with a solution under conditions suitable to extract substantially all non-carbohydrate components of the hulls, with the residue from the extraction comprising the holocellulose fraction of the corn hulls. As will be apparent to one of ordinary skill in the art, the exact amount of hemicellulose that remains in the residue will vary from sample to sample and from extraction to extraction. The extraction preferably is conducted under conditions sufficient to minimize loss of hemicellulose.

In accordance with a second method, alkaline hydrolysis may be carried out under conditions whereby an amount of water not exceeding 65% by weight of the corn hulls, and preferably ranging from 25 to 55% by weight of the corn hulls, is used to so that the hemicellulose does not migrate from the corn hull structure. The treated corn hulls then are contacted with a water-miscible solvent to extract the non-carbohydrate fraction, thereby leaving a holocellulose fraction.

The invention contemplates a pulp mimetic that is prepared by blending holocellulose with juice of a fruit or vegetable. In other embodiments, instead of juice, the holocellulose is blended with water and natural or artificial flavors of a fruit or vegetable to thereby provide a pulp mimetic. Any suitable fruit or vegetable juice may be used in conjunction with the invention. The “juice” of a fruit or vegetable is contemplated to be liquid portion of a fruit or vegetable that is obtained from the fruit or vegetable by suitable expression or squeezing. Depending on the degree of filtration of the juice, the solids content of the juice used in conjunction of the invention may vary from batch to batch. “Juice” is further contemplated to include juice that is concentrated, and/or juice that is reconstituted from concentrated juice. Synthetic juices may be provided and used in conjunction with the invention. If flavorings are added to an aqueous holocellulose mixture, this is contemplated to be a “juice” within the purview of the invention.

The juice is blended with holocellulose to prepare a pulp mimetic that has characteristics that simulate the pulp of the fruit or vegetable from which the juice was obtained. By this is contemplated that the viscosity of the pulp mimetic is similar to that of the pulp of the fruit or vegetable from which the juice was obtained (or, in the case of a synthetic juice, the pulp of the fruit or vegetable that the synthetic juice is intended to imitate). In addition, the pulp mimetic should have the characteristic flavor and odor of the pulp that the pulp mimetic is intended to mimic, and, in preferred embodiments, the pulp mimetic has a pH and a solids content that are each substantially similar to such pulp. The pulp of the fruit or vegetable by which the viscosity, flavor, odor, and other properties are referenced is a product that is obtained by mechanical working of that portion of the fruit or vegetable which is ordinarily deemed edible (for instance, in the case of citrus fruit, a puree of the peeled fruit).

Those skilled in the art will appreciate that a pulp mimetic that is satisfactory for most uses can be prepared even if the viscosity of the mimetic is not identical to the referenced fruit or vegetable pulp. Likewise, the flavor and odor of the pulp mimetic will not be in all cases identical to that of the referenced pulp. When the pulp mimetic is prepared, sufficient holocellulose may be added to impart the mimetic with a viscosity that falls within a pre-selected range of an intended viscosity, the intended viscosity being that of a sample of the referenced fruit or vegetable pulp. Thus, the invention can contemplate providing a fruit or vegetable juice (or synthetic juice as hereinbefore discussed) and selecting an amount of holocellulose effective to provide a pulp mimetic with a viscosity within a predetermined viscosity range surrounding an intended viscosity, and blending the juice (or synthetic juice) with the holocellulose to form the pulp mimetic. While the actual amounts will vary in practice, generally corn hull holocellulose should be blended with tomato juice in an amount of about 100 to about 300 grams per liter of juice to form a tomato paste mimetic. Likewise, about 10 to about 200 grams of holocellulose per liter of apple juice should be blended together to form an apple sauce mimetic. The mixture may be blended at any suitable temperature (typically room temperature), using any suitable means, such as a blender. Typical tomato paste mimetics have a viscosity that ranges from 42,000 to 52,000 cp at 25° C. (Brookfield, 20 RPM, #7 spindle), a pH of about 4 to about 5, and a solids content of about 12-17%. Typical apple sauces have a viscosity of 35 to 45 cp (Brookfield, 20 RPM, #7 spindle), a pH of 4 to 4.6, and a solids content of about 18-22%.

In either case, the starting juice may contain additional ingredients such as salt, sugar, spices, preservatives and the like, or alternatively these ingredients may be added to the pulp mimetic. Likewise, a colorant, such as food coloring, may be added in sufficient quantities to further approximate the color of the commercial tomato paste or apple sauce.

Holocellulose and water can replace the properties of body, mouthfeel, and texture normally imparted by fruit and vegetable pulp in food products where characteristic flavor is imparted by ingredients other than the fruit and vegetable pulp. Such products can include, but are not limited to, spice cookies, spice cakes, pies, meat loaf, pasta sauce, salad dressing, soup and gravy.

Holocellulose can be natural or synthetic. Synthetic holocellulose can be made by blending hemicellulose and cellulose. See e.g., EXAMPLE 5 below. The holocellulose described in the following passages and examples is a physical mixture of water soluble hemicellulose and water insoluble cellulose arabinoxylan.

The synthetic holocellulose may also be prepared by blending partially depolymerized hemicellulose with cellulose. The partially depolymerized hemicellulose can be obtained by any suitable method, but preferably is obtained by the partial depolymerization of a soluble hemicellulose precursor. The soluble hemicellulose precursor comprises or is obtained from the hemicellulose-containing soluble phase obtained by hydrolysis of a hemicellulose-containing plant source. In accordance with one embodiment of the invention, the partially depolymerized hemicellulose is obtained by the partial depolymerization of a soluble hemicellulose precursor that is substantially completely free of cellulose and other insoluble components from the plant source from which the hemicellulose is obtained, as taught in U.S. Pat. No. 6,063,178. As provided in more detail therein, the hemicellulose precursor most preferably is obtained from a soluble phase extracted from hydrolyzed destarched corn hulls produced by the corn wet milling industry.

In accordance with one embodiment of the invention, hemicellulose is removed from the hemicellulose-containing plant source in a soluble phase. Preferably, at least a majority of the hemicellulose component of the plant source, more preferably substantially all of the hemicellulose portion, is separated from insoluble components of the plant source. For example, when the hemicellulose-containing plant source comprises corn hulls, the soluble phase preferably is extracted from the corn hulls. The hemicellulose is extracted by heating an aqueous alkaline slurry of the corn hulls to a temperature of at least about 130° F. (54.5° C.), more preferably at least about 212° F. (100° C.), for a time sufficient to extract a substantial portion of the hemicellulose and other soluble components from the corn hulls. When the corn hull slurry is heated to boiling at atmospheric pressure, it has been found that the slurry should be heated with agitation for a time of at least about 60 minutes, more preferably at least about 80 minutes, and most preferably at least about 120 minutes, to extract the hemicellulose. This time may be substantially shortened if the corn hull slurry is cooked at higher temperatures under pressure. For example, corn hulls may be cooked at 315° F. (157° C.) at 70 psig for a time of about 5 minutes. Generally, any other reaction conditions as may be found to be suitable may be employed in conjunction with the invention.

Insolubles, for example, cellulose, are then physically removed from the reaction mixture, for example, by centrifugation. The soluble phase will contain hemicellulose and other soluble components. For example, it is believed that the soluble phase will contain protein hydrolyzate, salts of fatty acids, glycerin, and salts of natural acids, such as ferulic acid and coumaric acid. It should be understood that although the foregoing represents the preferred method of obtaining the hemicellulose precursor, any hemicellulose obtained via any method may be depolymerized and used in connection with the invention.

After the hemicellulose precursor is obtained, the soluble hemicellulose and other soluble components of the corn hulls then may be concentrated, or water may be removed substantially completely, such as by evaporation or spray-drying, to provide a solid hemicellulose-containing soluble phase. The hemicellulose in the hemicellulose-containing soluble phase can then be depolymerized in any suitable manner as described hereinbelow, and used in accordance with the present invention. Alternatively, the hemicellulose in the hemicellulose solution may be depolymerized prior to concentration and the resulting product optionally concentrated and used. It is further contemplated that the hemicellulose may be partially depolymerized prior to separation of the hemicellulose in a soluble phase from insoluble portions of a hydrolyzed plant source, although such is not presently contemplated to be preferred.

The hemicellulose can be partially depolymerized by any suitable method known in the art or otherwise as may be found to be suitable. The term “partially depolymerized,” as used herein refers generally to the product obtained when hemicellulose is subjected to a depolymerization reaction under conditions such that a partially depolymerized hemicellulose is obtained. Partial depolymerization of cellulose and hemicellulose are known in the art and can be accomplished, for example, enzymatically or chemically. Enzymatic partial depolymerization is described, for example, in U.S. Pat. Nos. 5,200,215 and 5,362,502. Chemical partial depolymerization is described, for example, in R. L. Whistler and W. M. Curbelt, J. Am. Chem. Soc., 77, 6328 (1955). The product of partial depolymerization of the hemicellulose has not been characterized with certainty, but it is presently believed that partial depolymerization by enzymatic methods occurs via random enzymatic cleavage.

Preferably, the partial depolymerization reaction is carried out enzymatically, i.e., under enzymatic catalysis. In a preferred embodiment, the hemicellulose is partially depolymerized with a xylanase enzyme, such as a xylanase that is active under acidic pH. In such case, the pH of the hemicellulose-rich soluble phase of the alkaline hydrolyzate typically is undesirably high and should be adjusted to a pH at which the depolymerizing enzyme is active. When a xylanase that is active under acidic conditions is used, the xylanase is preferably one which is active in the hemicellulose-containing soluble phase below about pH 7, and is most preferably active in the hemicellulose-containing soluble phase at about pH 4.8. In a particularly preferred embodiment, the enzyme utilized in the enzymatic partial depolymerization reaction is GC-140 xylanase, which is available from Genencor International, Rochester, N.Y.

Enzymatic partial depolymerization of hemicellulose may be regulated by controlling the reaction conditions that affect the progress of the depolymerization reaction, for example, the enzyme dosage, temperature, and reaction time. Monitoring of the depolymerization reaction can be accomplished by any suitable method known in the art. For example, the rate or extent of depolymerization can be measured on the basis of viscosity, which typically decreases as the average molecular weight of hemicellulose product decreases during the partial depolymerization reaction. The viscosity (or the rate of change of viscosity over time) can be measured with a viscometer, for example, the rapid viscometer marketed by Foss Food Tech. Corp., Eden Prairie, Minn. When a rapid viscometer is used to measure viscosity, it is preferably measured at 25° C. after the solution is allowed to equilibrate thermally for about 15 minutes.

Any enzyme dosage (weight of enzyme relative to the overall weight of solution) as may be found to be suitable for depolymerizing the hemicellulose may be used in connection with the invention. For example, in one embodiment xylanase enzyme is used at a dosage ranging from about 0.1 g to about 0.3 g of xylanase per about 5000 g of hemicellulose solution obtained from a plant source. It will be appreciated that the rate and/or the extent of depolymerization achieved at one enzyme dosage can be increased by using a relatively higher enzyme dosage. In this regard, the reaction time required to achieve partial depolymerization is inversely proportional to the enzyme dosage. It will also be appreciated that the enzymatic partial depolymerization reaction can exhibit a “plateau,” during the course of the enzymatic partial depolymerization reaction at which the average molecular weight of the partially depolymerized hemicellulose (as evaluated, for example, by viscosity measurements) does not substantially continue to decrease as the reaction continues. Typically, the plateau is preceded by a relatively rapid initial rate of partial depolymerization. It has been found, for example, that the partial depolymerization of a soluble phase hemicellulose solution having an initial viscosity of 290 cp (measured with a rapid viscometer) exhibited a plateau at a viscosity of about 199 cp when the enzyme dosage was 0.1288 g enzyme per 5000 g of hemicellulose solution (9.4% solids). However, when an enzyme dosage of 0.2542 g enzyme per 5000 g of solution was employed under similar conditions the reaction exhibited a plateau at a solution viscosity of about 153 cp. It will thus be appreciated that a particular enzymatic reaction may reach a plateau at a different average molecular weight depending on the enzyme dosage or on the particular enzyme used. Preferably, the enzymatic partial depolymerization is allowed to proceed until the plateau is reached.

The reaction may proceed at any suitable temperature. For example, when GC-140 xylanase (commercially available from Genencor International, Rochester, N.Y.) is used, the temperature is most preferably about 59° C., and the reaction time is most preferably about 4 hours when the xylanase dosage ranges from about 0.1 g to about 0.3 g of xylanase per about 5000 g of reaction solution. The enzymatic reaction can be terminated by any suitable method known in the art for inactivating an enzyme, for example, by adjusting the pH to a level at which the enzyme is rendered substantially inactive; by raising or lowering the temperature, as may be appropriate, or both. For example, xylanases that are active at acidic pH's can be inactivated by raising the pH to about 7.2 and simultaneously raising the temperature to about 90° C.

Any suitable ratio of hemicellulose to partially depolymerized hemicellulose may be used in conjunction with the invention.

The depolymerization of the hemicellulose may proceed to any suitable extent. Generally, it is desired that the partially depolymerized hemicellulose will still have a film-forming property. It is desired to partially depolymerize the hemicellulose in conjunction with the invention to achieve a lower viscosity than that of an otherwise similar hemicellulose, as evaluated in an aqueous solution at the same solids content and temperature. Hemicellulose derived from corn often have a molecular weight in the range of 220,000 Daltons; it is believed that partial depolymerization of this material to an average molecular weight of 70,000 Daltons will provide a partially depolymerized hemicellulose that is suitable for use in conjunction with the invention. In some embodiments of the invention, the hemicellulose may be partially depolymerized to a greater or lesser extent.

The isolation of corn hull hemicellulose from corn hulls is taught in the technical literature and is taught in the following patents: U.S. Pat. No. 2,801,955, U.S. Pat. No. 3,716,526, U.S. Pat. No. 2,868,778, and in U.S. Pat. No. 4,038,481. The isolation of cellulose arabinoxylan is taught in the technical literature (Cereal Chemistry. 78: 200-204). Additionally, the isolation of cellulose arabinoxylan is taught in EXAMPLE 4 below.

The following examples are provided to illustrate the invention, but should not be construed as limiting the invention in scope.

### EXAMPLE 1

Tomato Paste Mimetic Prepared from Corn Hull Holocellulose and Tomato Juice

Corn hull holocellulose, 74 g, was mixed into 340 mL of commercial tomato juice at room temperature by means of a hand-held blender. Red food coloring was added sufficient to reproduce the color of commercial tomato paste. The mixture was evaluated along with the commercial tomato paste. The following properties were evaluated or qualitatively determined.

| | | | Brookfield | | | |
|---|---|---|---|---|---|---|
| | | | Viscosity | | | |
| | | | (20 RPM | | | |
| | Solids | | #7 | Flowability | | |
| Product | % | pH | Spindle) | (Bostwick) | Aroma | Texture |
| Commercial | 22.8 | 4.5 | 54,600 | 0 cm/30 | Typical | Typical |
| Tomato | | | Centipoise | secs | Tomato | Tomato |
| Paste | | | | | Paste | Paste |
| Example 1 | 14.5 | 4.4 | 48,600 | 0 cm/30 | Typical | Typical |
| Product | | | Centipoise | secs | Tomato | Tomato |
| | | | | | Paste | Paste |

Commercial Tomato Paste and the Product of EXAMPLE 1 were formulated into a pasta sauce according to the following recipe. The ingredients in the sauce were simmered in a covered vessel for one hour. After simmering, the sauces were cooked and qualitatively evaluated.

| | Sauce with | | Sauce with | |
|---|---|---|---|---|
| | Commercial | | Product of | |
| Ingredient | Tomato Paste | | Example 1 | |
| Commercial Tomato Paste | 400 | g | 0 | g |
| Product of Example 1 | 0 | g | 400 | g |
| Oregano | 0.25 | teaspoon | 0.25 | teaspoon |
| Basil | 0.25 | teaspoon | 0.25 | teaspoon |
| Rosemary | 0.25 | teaspoon | 0.25 | teaspoon |
| Marjorum | 0.25 | teaspoon | 0.25 | teaspoon |
| Salt | 0.75 | teaspoon | 0.75 | teaspoon |
| Black Pepper | 0.25 | teaspoon | 0.25 | teaspoon |
| Sugar | 1.0 | tablespoon | 1.0 | tablespoon |
| Oil | 3.0 | tablespoons | 3.0 | tablespoons |
| Garlic | 0.50 | teaspoon | 0.50 | teaspoon |
| Onion Powder | 0.50 | teaspoon | 0.50 | teaspoon |
| Minced Onion | 0.50 | teaspoon | 0.50 | teaspoon |
| Water | 1.5 | cup | 1.0 | cup |

| Product | Taste | Aroma | Texture |
|---|---|---|---|
| Sauce with | Typical | Typical Tomato | Typical Tomato |
| Commercial | Tomato | Paste | Paste |
| Tomato Paste | Paste | | |
| Sauce with Product | Typical | Typical Tomato | Typical Tomato |
| of Example 1 | Tomato | Paste | Paste |
| | Paste | | |

### EXAMPLE 2

Apple Sauce Mimetic Prepared from Corn Hull Holocellulose and Apple Juice

Corn hull holocellulose, 74 g, was mixed into 680 mL of commercial apple juice at room temperature by means of a hand-held blender. The mixture was evaluated along with a commercial apple sauce. The following properties were evaluated or qualitatively determined.

| | Commercial | |
|---|---|---|
| | Apple Sauce | Product of Example 2 |
| Solids | 22.3% | 20.7% |
| pH | 3.4 | 4.3 |
| Brookfleld Viscosity (20 | 26.7 Centipoise | 40.5 Centipoise |
| RPM #6 Spindle) | | |
| Flowablility | 4.0 cm./30 sec. | 1.5 cm./30 sec. |
| Taste | Typical Apple Sauce | Typical Apple Sauce |
| Aroma | Typical Apple Sauce | Typical Apple Sauce |
| Texture | Typical Apple Sauce | Typical Apple Sauce |

### EXAMPLE 3

Cookies Made with Holocellulose to Replace Apple Sauce Mimetic

Spice cookies were prepared with apple sauce at 21.0% solids according to the following standard recipe: Cream together 0.5 cup white sugar and 0.25 cup shortening. Add one egg and beat. Sift together 0.75 cup flour, 0.25 teaspoon salt, 1.0 teaspoon ground cinnamon, 0.5 teaspoon ground nutmeg, and 0.5 teaspoon ground cloves. Combine 0.5 cup applesauce with 0.5 teaspoon baking soda. Blend sifted dry ingredients into the creamed mixture alternately with the applesauce mixture. Fold in 0.5 cup raisins and 0.5 cup crushed corn flakes. Drop by teaspoonfuls onto greased cookie sheet and bake at 375° F. for 20 minutes.

The recipe for spice cookies was repeated with an aqueous slurry of corn hull holocellulose at 9.89% solids used in place of the apple sauce. Holocellulose at 9.89% solids had the consistency and performance of apple sauce at 21.0% solids. The bouquet of applesauce was not apparent in the control as it was overwhelmed by the aromatic spices. A sensory panel judged the two batches of cookies and found them comparable for mouthfeel, texture, flavor, and appearance.

### EXAMPLE 4

Continuous Process for the Preparation of Cellulose Arabinoxylan

Dried corn hulls from a corn wet milling process of US Number 2 grade hybrid yellow dent corn are ground to a particle size suitable for jet cooking. The ground corn hulls, 346 pounds as is basis, are placed into 480 gallons of water to form a slurry. NaOH (50%) is added (800 mL) to the slurry in order to achieve a pH of 6.6 at 70° F.

The resulting slurry is continuously jet-cooked in a continuous jet cooker equipped with a Hydroheater Combining Tube which inflicts high shear into the slurry at the point of contact with the high pressure steam at ˜150 psig. The jet-cooking conditions are: Temperature=220° F. to 225° F., Pressure=˜20 psig, Retention Time=4.5 minutes.

The cooked corn hulls are recovered from the cooked slurry by feeding the cooked slurry across a screen having an effective size to separate liquids and solids at high pressure, such as a DSM Screen. The DSM filtered cooked corn hulls are added to a well-agitated tank of 360 gallons of water at 180° F.

The cooked corn hulls are recovered a second time from the slurry at 180° F. by feeding the slurry at 180° F. across a DSM Screen at high pressure. The DSM filtered cooked corn hulls are added to a well-agitated tank of 360 gallons of water at 180° F.

The cooked corn hulls are recovered a third time from the slurry at 180° F. by feeding the slurry at 180° F. across a DSM Screen at high pressure. The DSM filtered cooked corn hulls are added to a well-agitated tank of 360 gallons of water at 180° F.

Calcium Hydroxide (40 pounds) is added to the well agitated slurry. The resulting slurry is continuously jet-cooked in a continuous jet cooker equipped with a Hydroheater Combining Tube which inflicts high shear into the slurry at the point of contact with high pressure steam at ˜150 psig. The jet-cooking conditions are: Temperature=325° F. to 335° F., Pressure=˜95 psig, Retention Time=27 minutes.

The resultant cooked paste is jet-cooked a second time with high pressure steam at ˜150 psig. The jet-cooling conditions are: Temperature=325° F. to 335° F., Pressure=˜95 psig, Retention Time=30 seconds.

The solubilized, extractable hemicellulose and other soluble materials such as polypeptides, phenoxyacid salts, and acetic acid salts, are removed from the remaining cellulose arabinoxylan by centrifugation with a Sharpies P-660 centrifuge. The cellulose arabinoxylan wet cake (300 pounds) is added to water (100 gallons) at 180° F., the pH of the slurry is adjusted to about 7.0 with hydrochloric acid, and the washed cellulose arabinoxylan recovered by centrifugation with a Sharpies P-660 centrifuge. The washing procedure is repeated twice, and the cellulose arabinoxylan is dried in suitable equipment.

If desired, the first slurry of cellulose arabinoxylan is bleached with hydrogen peroxide before the bleached cellulose arabinoxylan is recovered by centrifugation with a Sharpies P-660 centrifuge. Residual oxidant is neutralized by the addition of sodium metabisulfite to the second slurry before recovery of the remaining cellulose arabinoxylan by centrifugation with a Sharpies P-660 centrifuge.

### EXAMPLE 5

Synthetic Holocellulose

The natural holocellulose used in EXAMPLES 1, 2, and 3 were assayed to contain 53 parts by weight hemicellulose with 47 parts by weight cellulose arabinoxylan. A Synthetic Holocellulose is fabricated using the same ratio by combining 53 parts by weight hemicellulose with 47 parts by weight cellulose arabinoxylan. Synthetic Holocellulose is used to replace the natural holocellulose in EXAMPLES 1, 2, and 3 to give EXAMPLES 6, 7, and 8, respectively.

### EXAMPLE 6

Tomato Paste Substitute Prepared from Synthetic Holocellulose and Tomato Juice

Synthetic Holocellulose from EXAMPLE 5, 74 g, is mixed into 340 mL of commercial tomato juice at room temperature by means of a hand-held blender. Red food coloring is added sufficient to reproduce the color of commercial tomato paste. The result is the Product of EXAMPLE 6.

Commercial Tomato Paste and the Product of EXAMPLE 6 are formulated into a pasta sauce according to the following recipe which is simmered in a covered vessel for one hour.

| | Sauce made | | Sauce made with | |
|---|---|---|---|---|
| | with Control | | Product of | |
| Ingredient | Tomato Paste | | EXAMPLE 6 | |
| Tomato Paste | 400 | g | 0 | g |
| Product of EXAMPLE 6 | 0 | g | 400 | g |
| Oregano | 0.25 | teaspoon | 0.25 | teaspoon |
| Basil | 0.25 | teaspoon | 0.25 | teaspoon |
| Rosemary | 0.25 | teaspoon | 0.25 | teaspoon |
| Marjorum | 0.25 | teaspoon | 0.25 | teaspoon |
| Salt | 0.75 | teaspoon | 0.75 | teaspoon |
| Black Pepper | 0.25 | teaspoon | 0.25 | teaspoon |
| Sugar | 1.0 | tablespoon | 1.0 | tablespoon |
| Oil | 3.0 | tablespoons | 3.0 | tablespoons |
| Garlic | 0.50 | teaspoon | 0.50 | teaspoon |
| Onion Powder | 0.50 | teaspoon | 0.50 | teaspoon |
| Minced Onion | 0.50 | teaspoon | 0.50 | teaspoon |
| Water | 1.50 | cup | 1.0 | Cup |

### EXAMPLE 7

Apple Sauce Substitute Prepared from Synthetic Holocellulose and Apple Juice

Synthetic Holocellulose from EXAMPLE 5, 74 g, is mixed into 680 ml of commercial apple juice at room temperature by means of a hand-held blender.

### EXAMPLE 8

Cookies made with Synthetic Holocellulose to Replace Apple Sauce

Spice cookies are prepared with apple sauce at 21.0% solids according to the following standard recipe. Cream together 0.5 cup white sugar and 0.25 cup shortening. Add one egg and beat. Sift together 0.75 cup flour, 0.25 teaspoon salt, 1.0 teaspoon ground cinnamon, 0.5 teaspoon ground nutmeg, and 0.5 teaspoon ground cloves. Combine 0.5 cup applesauce with 0.5 teaspoon baking soda. Blend sifted dry ingredients into the creamed mixture alternately with the applesauce mixture. Fold in 0.5 cup raisins and 0.5 cup crushed corn flakes. Drop by teaspoonfuls onto greased cookie sheet and bake at 375° F. for 20 minutes.

The recipe for spice cookies is repeated with an aqueous slurry of Synthetic Holocellulose from EXAMPLE 5, at 9.89% solids used in place of the apple sauce.

It is thus seen that holocellulose can be used to prepare pulp mimetics.

While the invention has been described with respect to specific examples including presently preferred modes of carrying out the invention, those skilled in the art will appreciate that there are numerous variations and permutations of the above described systems and techniques. For instance, the invention has been described primarily in contemplation of the preparation of tomato and apple pulp mimetics, but the invention is deemed equally applicable in the context of other pulp mimetics.

All references cited herein are hereby incorporated by reference in their entireties.

All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention. No language in the specification should be construed as indicating that any non-claimed element is essential to the practice of the invention.

Preferred embodiments of this invention are described herein, including the best mode known to the inventors for carrying out the invention. Variations of those preferred embodiments may become apparent to those of ordinary skill in the art upon reading the foregoing description. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A pulp mimetic comprising a mixture of holocellulose and the juice of a fruit or vegetable in amounts sufficient to simulate a pulp of the fruit or vegetable.

2. The pulp mimetic of claim 1, said juice comprising apple or tomato juice.

3. A pulp mimetic according to claim 1, said holocellulose comprising corn hull holocellulose.

4. A pulp mimetic according to claim 1, said holocellulose comprising natural holocellulose.

5. A pulp mimetic according to claim 1, said holocellulose comprising synthetic holocellulose.

6. The pulp mimetic of claim 2, comprising a mixture of corn hull holocellulose and tomato juice in a ratio of about 100 to about 300 grams of corn hull holocellulose to one liter of tomato juice.

7. The pulp mimetic of claim 6, said pulp mimetic having a pH of about 4 to about 5.

8. The pulp mimetic of claim 3 wherein the viscosity of the pulp mimetic ranges from about 42,000 to about 52,000 centipoise at 25°.

9. The pulp mimetic of claim 3 wherein the solids content of said pulp mimetic ranges from about 12 to about 17%.

10. The pulp mimetic of claim 2, comprising a mixture of corn hull holocellulose and apple juice in a ratio of about 10 to about 200 grams of corn hull holocellulose to one liter of apple juice.

11. The pulp mimetic of claim 10 wherein the pulp mimetic has a pH of about 4.0 to about 4.6.

12. The pulp mimetic of claim 10 wherein the viscosity of the pulp mimetic is about 35 to about 45 centipoise at 25° C.

13. The pulp mimetic of claim 10 wherein the solids content of such pulp mimetic ranges from about 18 to about 22%.

14. A method for preparing a pulp mimetic, comprising mixing holocellulose and juice of a fruit or vegetable in amounts sufficient to simulate a pulp of the fruit or vegetable.

15. The method of claim 14, wherein said holocellulose comprises corn hull hemicellulose.

16. The method of claim 14, wherein said holocellulose comprises natural holocellulose.

17. The method of claim 14, wherein said holocellulose comprises synthetic holocellulose.

18. The method of claim 14, said juice comprising tomato juice.

19. The method of claim 14, said juice comprising apple juice.

20. A pulp mimetic comprising a mixture of holocellulose, water, and flavorings intended to simulate a fruit or vegetable, the holocellulose, water, and flavorings being present in amounts sufficient to simulate a pulp of the fruit or vegetable.

21. The pulp mimetic of claim 20, wherein said holocellulose comprises natural holocellulose.

22. The pulp mimetic of claim 20, wherein said holocellulose comprises synthetic holocellulose.

23. A process for preparing a pulp mimetic, comprising mixing holocellulose, water, and flavoring, the flavoring being present in an amount effective to simulate the flavor and aroma of a fruit or vegetable, the holocellulose, water, and flavoring being present in amounts effective to simulate a pulp of the fruit or vegetable.

24. The process of claim 23, wherein said holocellulose comprises natural holocellulose.

25. The process of claim 23, wherein said holocellulose comprises synthetic holocellulose.

26. A process for preparing a pulp mimetic, comprising:
providing a juice of a fruit or vegetable;
selecting an amount of holocellulose effective to blend with said juice to thereby form a pulp mimetic having a viscosity that is within a predetermined range surrounding an intended viscosity, said intended viscosity being determined based on the viscosity of a pulp of the fruit or vegetable; and
blending said holocellulose and said juice to thereby form a pulp mimetic.

27. The process of claim 26, wherein said holocellulose comprises natural holocellulose.

28. The process of claim 26, wherein said holocellulose comprises synthetic holocellulose.

29. A method for preparing a composite food product, the method comprising:
providing a pulp mimetic, said pulp mimetic comprising holocellulose and the juice of a fruit or vegetable, said holocellulose and juice being present in amounts sufficient to simulate a pulp of the fruit or vegetable;
blending said pulp mimetic with at least one additional food ingredient to thereby form a composite food product.

30. The method of claim 29, wherein said holocellulose comprises natural holocellulose.

31. The method of claim 29, wherein said holocellulose comprises synthetic holocellulose.

32. A composite food product prepared according to claim 29.

33. A method according to claim 29, said additional food ingredients comprising at least two ingredients selected from the group consisting of oregano, basil, garlic, onion, and salt, said composite food product comprising a pasta sauce.
